(19) United States
(12) Patent Application Publication
(10) Pub. No.: US 2006/0162166 A1
(43) Pub. Date: Jul. 27, 2006

(54) Operating assembly and device including such an operating assembly

(75) Inventors: Mattheus Jacobus Van Der Meer, Drachten (NL); Jan Postma, Drachten (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/545,647

(22) PCT Filed: Feb. 19, 2004
(86) PCT No.: PCT/IB04/50132

§ 371 Date: Aug. 16, 2005

(30) Foreign Application Priority Data
Feb. 21, 2003 (EP) 03100415.3

(51) Int. Cl. B26B 19/42

(52) U.S. Cl. 30/34.2

(57) ABSTRACT

An operating assembly comprises a support structure (9), a user-operable operating member (7) movable in at least one direction of movement (10, 11) relative to the support structure (9) between a plurality of positions supported by the support structure (9); an array (14) of catches (15) extending along the direction of movement (10, 11); and a clicking pawl (16) resiliently accommodated for consecutive engagement with and disengagement from consecutive ones of the catches (15) of the array (14) in response to a movement of the operating member (7) in the direction of movement (10, 11). At least the clicking pawl (16) or the array (14) of catches (15) is accommodated with clearance (32) in the direction of movement (10, 11). A device comprising such an operating assembly is also described.

This invention relates to an operating assembly for controlling a setting of a device and to a device comprising such an operating assembly.

In both continuously and stepwise adjustable controls, there are various reasons for providing the user with positive feedback during operations for indicating that, and in some cases also by how much, a controlled setting has been changed.

For instance, portable devices and devices for installation in vehicles or vessels often need to be operated while the user and/or the device are subject to movements and/or vibrations. It is relatively difficult in such situations to accurately control continuous controls. Means for generating a clicking feedback are therefore included in such operating assemblies. Examples of such applications are volume and other control knobs in portable and automotive environments and control knobs of power tools. Another example of such a solution is shown in U.S. Pat. No. 3,768,160.

Another situation in which feedback indicating the amount of adjustment is desirable is where a clear distinction between movement and a fixed position is desired, such as in a so-called scroll wheel in a pointer operating device such as a computer mouse.

Yet another situation in which feedback indicating the amount of adjustment is desirable is where the operating member is used for selecting between distinct positions, such as turn-and-push knobs or thumb wheels for operating an operating interface comprising a display showing menus of options and allowing to switch between selected options by rotating a knob or thumb wheel and activating the selected option by pushing the knob or thumb wheel. Another example of such a knob is a knob for selecting between distinct operating modes, for instance for selecting sources in an audio or video system, between programs of a washing machine, or between lighting settings in a motor vehicle.

Although various solutions are available for generating some feedback, up to stepper motors that can generate various indexing patterns, there is still a need for a simple solution generating a particularly clear and, more in particular, clearly audible feedback to the user.

It is an object of the present invention to provide a simple yet durable solution for generating a clear and in particular clearly audible feedback to the user operating an operating member for controlling a setting of a device. According to the present invention, this object is achieved by providing an operating assembly according to claim 1.

In operation, when the operating member is moved to make an adjustment, at least the clicking pawl or at least one catch of the array of catches that is accommodated with clearance is initially urged into one extreme position of its range of clearance. After the pawl has moved past a dead center position or range relative to the catch or catches, the pawl comes into engagement with a next one of the catches. This causes the force components parallel to the direction of movement that the pawl and the catch or catches exert on each other to be inverted, which in turn causes at least the clicking pawl or at least one catch of the array of catches that is accommodated with clearance to be shifted from its extreme position towards the opposite extreme position (which does not necessarily need to be reached). This latter movement occurs with a high velocity and is suddenly stopped as the new position of at least the clicking pawl or at least one catch of the array of catches is reached. This causes a clicking sound emission and a small shock that may be transferred to the user as a tactile support of the audible feedback.

The invention is based on the recognition that click effects generated in manually operated operating members are conventionally inhibited to a major extent, because the user holding the operating member inherently hinders any quick movement of the operating member, for instance into an indexing position, and any abrupt stopping of the operating member. Since at least the clicking pawl, each of the catches, or the array of catches is mounted with clearance in the direction of movement of the operating member, these parts are allowed to shift quickly into preferred positions, thereby generating an effective clicking sound, even if the operating member is moved slowly.

Particular embodiments of the invention are set forth in the dependent claims. The invention may also be embodied in a device according to claim 12, which includes an operating assembly according to the invention.

Further features, effects and details of the invention appear from the detailed description of a preferred embodiment and another embodiment shown in the drawings.

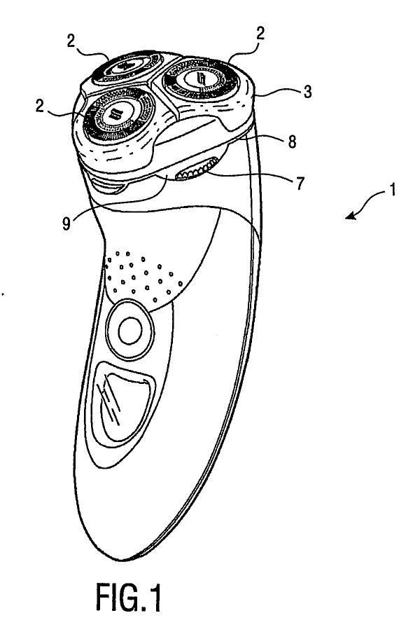

FIG. 1 is a perspective view of an example of a device according to the invention comprising an operating assembly according to the invention;

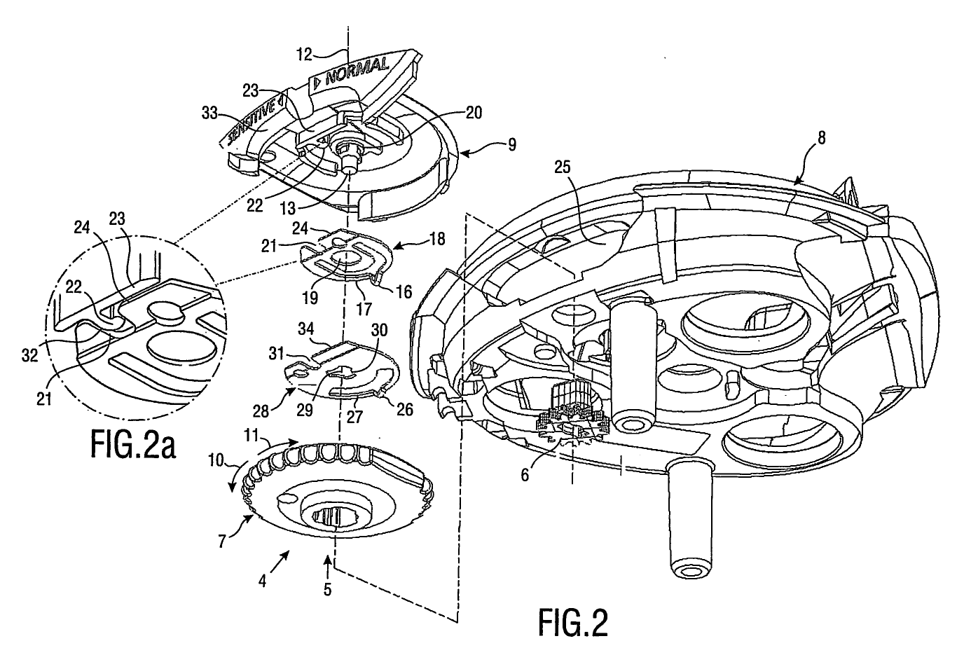

FIG. 2 is a perspective, exploded view from below of an adjustment assembly comprising an operating assembly according to the invention;

FIG. 2a is an enlarged and detailed view of the support structure and carrier plate in an assembled position;

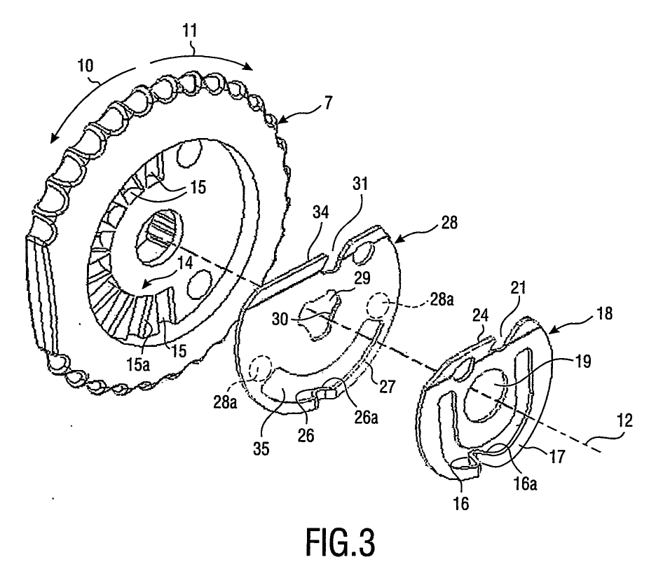

FIG. 3 is an enlarged, perspective, exploded view from above of an operating member and of clicking and indexing pawls of the assembly according to FIG. 2;

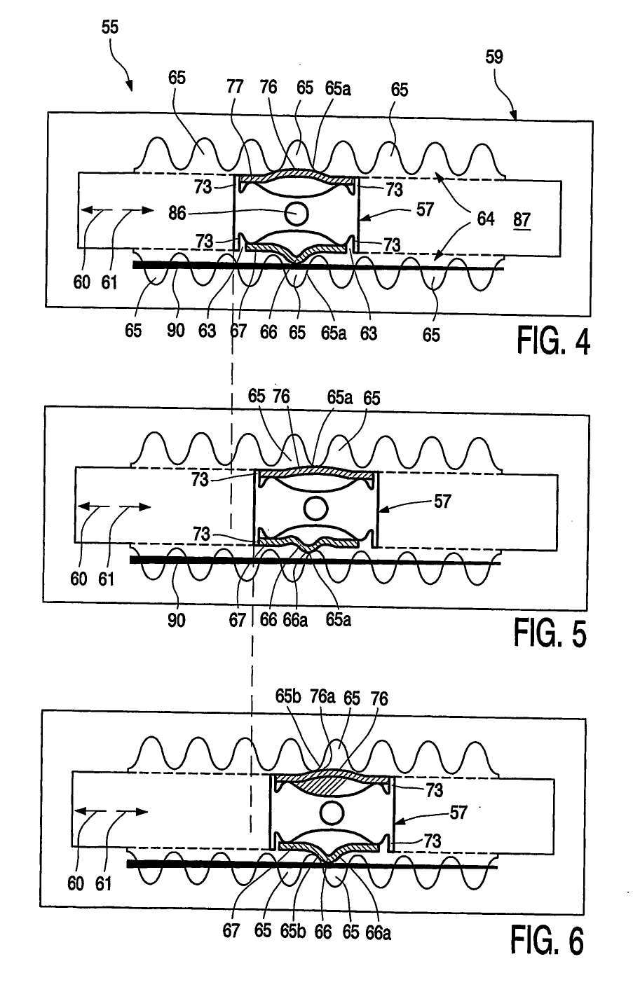

FIGS. 4, 5 and 6 are schematic top plan views of a second example of an operating assembly according to the invention in different operating situations; and

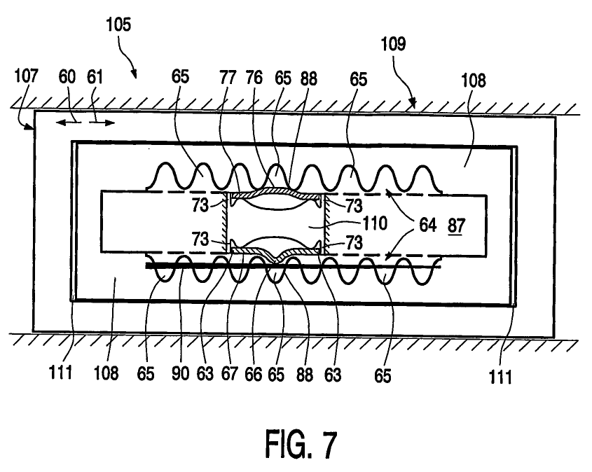

FIG. 7 is a schematic top plan view of a third example of an operating assembly according to the invention.

First, an example of an application of the present invention to a dry shaver 1 is described.

The shaver 1 shown in FIG. 1 comprises three shaving heads 2, resiliently accommodated in a shaving head holder 3 for pressing the shaving heads 2 outwards into an outermost position. A contact pressure to the skin to be shaved is required to press the shaving heads 2 inwards into a shaving position approximately flush with the shaving head holder 3. The shaver 1 further comprises an adjustment structure 4 for adjusting the contact pressure. The adjustment structure 4 comprises an operating assembly 5 and a transmission gear wheel 6 that engages an adjustable support (not shown) of a resilient pressure member for exerting the contact pressure on the shaving head. The higher the contact pressure, the closer the shave (in other words, the greater the shaving depth) that is obtained. However, for sensitive skin portions a high contact pressure frequently leads to skin irritation, so that it is desirable to be able to switch quickly to an operational setting in which the contact pressure required for pressing the shaving heads 2 into the flush positions is lower. It will be clear that the shaving positions of the shaving heads 2 flush with the shaving head holder 3 are not to be understood as perfectly flush positions, but positions that are flush by approximation only and that vary with the shape and stiffness of the facial portion against which the shaving heads 2 and the shaving head holder 3 are held. The operating member 7 for the adjustment of the shaving depth is provided in the form of a thumb wheel under a base 8 to which the shaving head holder 3 is mounted. Shavers with such a shaving depth adjustment are commercially available in the form of shavers of the Philips Sensotec product line.

According to this example of the present invention, an operating assembly 5 (see FIGS. 2 and 3) is provided that has been improved for generating a more positive feedback in the form of clicking when the thumb wheel 7 is operated. Such clicking provides a clearly audible indication of the extent to which the shaving depth is adjusted and may also be felt through the thumb wheel 7.

The operating assembly comprises a support structure 9 relative to which the thumb wheel 7 is moveable in opposite rotational directions (arrows 10, 11) about an axis of rotation 12. For this purpose, the thumb wheel 7 is rotatably mounted on a bearing stub 13.

The thumb wheel 7 is provided with an array 14 of catches—of which some are designated by reference numerals 15—extending the directions of movement 10, 11. According to this example, the array 14 is provided in the topmost face of the thumb wheel 7, but other positions, such as the lowermost face or the periphery of the thumb wheel 7 or positions on the support structure 9, are conceivable as well.

A clicking pawl 16 is resiliently accommodated for consecutive engagement with and disengagement from consecutive catches 15 of the array 14 in response to a movement of the thumb wheel 7 in one of the directions of movement 10, 11. The clicking pawl 16 is integrally formed with a leaf spring 17 that in its turn is cut from steel plating integrally with a carrier plate 18. The carrier plate 18 is provided with a circular hole 19 adapted to receive a base portion 20 of the stub 13 with a non-clamping (for instance sliding or loose) fit. In mounted position, the clicking pawl 16 is thus rotatable co-axially with the thumb wheel 7 about the stub 13, and the array 14 of catches 15 extends coaxially with the thumb wheel 7.

However, the carrier plate 18 is provided with a recess 21 receiving a projection 22 from a flange 23 of the support structure 9. This limits the freedom of rotation of the carrier plate 18 and the clicking pawl 16 connected thereto about the axis 12 to a certain clearance 32 in the direction of movement of the thumb wheel 7 (see detail FIG. 2a). Furthermore, the carrier plate 18 has a flat side 24 closely adjacent the downwardly projecting flange 23 of the support structure 9 which would also limit the freedom of rotation of the carrier plate 18 about the axis 12 in the absence of the projection 22 extending into the recess 21.

The support structure 9, to which the thumb wheel 7 is rotatably mounted, is mounted in a recess 25 in the base 8 under the shaving head holder 3, and a section of the thumb wheel 7 projects from a recess 33 in the support structure 9 so that it can be operated by the thumb or index finger of the hand of the user.

In operation, if the thumb wheel 7 is rotated for instance clockwise (direction of rotation indicated by arrow 10), the clicking pawl 16, which is engaged in one of the catches 15, is initially entrained in the same direction of rotation about the axis 12, until the limit of the freedom of rotation relative to the support structure 9 of the unit comprising the clicking pawl 16, the leaf spring 17, and the carrier plate 18 has been reached. Then, as the thumb wheel 7 is rotated further, the catch 15 in which the clicking pawl 16 was engaged moves further, so that the clicking pawl 16 is pressed from the catch 15 by the trailing flank 15a or edge of that catch 15 and urged away from the thumb wheel 7 against the force exerted on the clicking pawl 16 by the leaf spring 17 that presses the clicking pawl 16 against the array 14 of catches. As the thumb wheel 7 is turned further, a next catch 15 of the array 14 of catches 15 reaches the clicking pawl 16. Because of the clearance 32 in the direction of rotation with which the clicking pawl is accommodated, the clicking pawl 16 can slip into the next catch 15 very quickly under the influence of the action of the leaf spring 17, even if the thumb wheel 7 is rotated very slowly. This effect is achieved because the clearance with which the clicking pawl 16 is accommodated allows the clicking pawl 16 to shift back slightly against the direction of rotation of the thumb wheel 7 while slipping into the next catch 15. In the absence of such a clearance 32, the rate at which the clicking pawl 16 could slip into the next catch 15 would be determined by the slope of at least one of mutually contacting surfaces of the clicking pawl and the catch relative to the direction of displacement of the operating member in the area of the catch and the clicking pawl, and by the velocity with which the thumb wheel 7 is rotated.

The quick engagement of the clicking pawl 16 with the catches 15 results in the clicking pawl 16 and the leaf spring 17 abruptly stopping when reaching their next positions associated with engagement of the clicking pawl 16 with one of the catches 15. This abrupt stopping causes the desired audible clicking effect. For a clear clicking action, it is also advantageous that the parts that are allowed to accelerate owing to clearance with respect to the slowly moving operating member 7 are of a weight that is substantially smaller than the weight of the operating member 7, so that a relatively small amount of energy, stored in the leaf spring when the clicking pawl 16 is pressed inwards will suffice to cause it to spring back very quickly, thus causing a clearly audible clicking sound. It is observed, however, that it is also within the scope of the present invention to allow portions of the support structure to move along with the clicking pawl within a range of clearance in an operating direction relative to the rest of the operating member 7.

For an effective clicking effect, it is furthermore advantageous if the materials that hit each other for causing the clicking effect are relatively hard and exhibit little damping, such as metal, hard plastic, or ceramic material. Furthermore, thin-walled constructions are advantageous for the clicking elements as such elements typically have relatively large surfaces for converting shocks of the elements into sound.

The amount of clearance 32 of the clicking pawl 16 in the direction of movement of the thumb wheel 7 is preferably at least such that the clicking pawl 16 can slide from one extreme position within its range of clearance and at the edge of a catch 15 away from that position into a position fully engaging the respective catch 15 without requiring any rotation of the thumb wheel. Thus an effective clicking action is ensured. On the other hand, for obtaining a fairly accurate feedback, the amount of clearance 32 (movability) of the clicking pawl 16 in the direction of movement of the thumb wheel 7 is preferably less than the pitch and more preferably less than one half of the pitch between consecutive catches 15.

Although the obtained clicking action is already by itself very useful for providing feedback indicating the operation of the operating member 7, a particularly positive feedback is achieved if the clicking action is associated with the reaching of predetermined indexing positions of the operating member 7, in which the operating member 7 is maintained at least under normal operating circumstances and without operation of the operating member by the user. To achieve this, the operating assembly 5 further comprises an indexing structure for retaining the operating member 7 in each of a plurality of consecutive and predetermined indexing positions. The indexing positions are determined such that the clicking pawl 16 is in engagement with one of the catches 15 if the operating member 7 is in one of the indexing positions.

According to the present example, this is achieved in a simple manner by providing the indexing structure with an indexing pawl 26 resiliently accommodated for consecutive engagement with and disengagement from the array 14 of catches 15 in response to a movement of the operating member 7 in one of the directions of movement 10, 11.

A compact and simple construction with reliable synchronization of the operation of the indexing pawl 26 and the clicking pawl 16 is obtained because the indexing pawl 26 and the clicking pawl 16 are arranged for engagement with and disengagement from the same array 14 of catches 15. For the compactness of the operating assembly, it is furthermore advantageous that the clicking pawl 16 and the indexing pawl 26 operate with the same array of catches 15, or that the tracks of the array or arrays of catches along which the indexing pawl 26 and the clicking pawl 16 are operative extend coaxially with each other.

Like to the clicking pawl 16, the indexing pawl 26 is also integral with the leaf spring 27 which is a portion of a mounting plate 28. The clicking pawl 16 extends through an opening 35 of the mounting plate 28 adjacent the leaf spring 27 so that a compact, flat and simple construction is also obtained. However, in contrast to the hole 19 in the carrier plate 18 integral with the clicking pawl 16, the hole 29 in the mounting plate 28 integral with the indexing pawl 26 is provided with clamping flanges 30 for fixedly engaging the stub 13. Furthermore, the recess 31 in a straight side 34 of the mounting plate 28 for engaging the projection 22 from the flange 23 of the support structure 9 is narrower than the recess 21 in the carrier plate 18 integral with the clicking pawl 16. Accordingly, the indexing pawl 26 is accommodated relative to the support structure with no or at most significantly less movability relative to the support structure 9 in the directions of movement 10, 11 of the thumb wheel 7 than the clicking pawl 16, which is advantageous for the accuracy of the indexing function.

The leaf spring 17 carrying the clicking pawl 16 extends closely adjacent the mounting plate 28 carrying the indexing pawl 26 for causing the leaf spring 17 carrying the clicking pawl 16 to hit the mounting plate 28 when the clicking pawl 16 moves quickly towards one of the catches 15. The leaf spring 17 hits the mounting plate 28 at the locations 28a near the edges of the opening 35. Preferably, the mounting plate 28 is a metal plate, so that a distinctly audible “metallic” clicking action is obtained in a very flat and simple construction. It is also observed that the plate-shaped units comprising the clicking pawl 16 and the indexing pawl 26 as well as the thumb wheel 7 can be mounted to the support structure 9 in a common direction parallel to the axis 12, so that the operating assembly 5 is particularly suitable to be assembled automatically.

Irrespective of the direction of movement 10, 11 of the thumb wheel 7, the clicking pawl 16 and the indexing pawl 26 each have a flank 16a, 26a, respectively, trailing with respect to the movement of the pawls 16, 26 relative to the array 14 of catches 15. As is best seen in FIG. 3, the flanks 16a of the clicking pawl 16 are steeper than the flanks 26a of the indexing pawl 26 so that, irrespective of the direction of movement, the trailing flank 16a of the clicking pawl 16 is steeper than the trailing flank 26a of the indexing pawl 26. Thus, on the one hand a smooth indexing action and, on the other hand, quick movements of the clicking pawl 16 and accordingly effective clicking action are achieved. It is observed that this effect may also be achieved if the flank 16a of clicking pawl is steeper than the flank 26a of the indexing pawl on one (and the same) side, if the operating member is adapted to be operated in one direction only. For such a function, the catches and/or the pawls may be of a sawtooth design to prevent movement of the operating member in the opposite direction.

To obtain a quick movement of the clicking pawl and a smooth indexing action, it is also advantageous if the trailing flanks 16a or flank portions of the clicking pawl 16 are steeper than the trailing flanks 26a or flank portions of the indexing pawl 26.

FIGS. 4, 5 and 6 show a second example of an operating assembly 55 according to the invention. The operating assembly 55 has an operating member 57 with an operating knob 86. The operating member 57 is slideable in opposite directions of movement 60, 61 in a linear guide slot 87 formed in the support structure 59. The support structure 59 is provided with arrays 64 of catches 65 extending parallel to each other on opposite sides of the guide slot 87.

On one side of the operating member 57, a clicking pawl 66 is arranged in the form of a bump integral with a leaf spring 67 and facing one of the arrays 64. On the opposite side of the operating member 57, an indexing pawl 76 is arranged in the form of a bump integral with a leaf spring 77 and facing the opposite one of the arrays 64. The leaf spring 67 with which the clicking pawl 66 is integral is retained between flanges 73 of the operating member 57 with some clearance 63 parallel to the directions 60, 61 in which the operating member 57 is moveable. The leaf spring 77 with which the indexing pawl 76 is integral is also retained between flanges 73 of the operating member 57, but with significantly less clearance parallel to the directions 60, 61 in which the operating member 57 is moveable than the clearance in that direction with which the clicking pawl 66 and the spring 67 are enclosed. The clearance between the leaf spring 77 with which the indexing pawl 76 is integral and the flanges 73 is just sufficient to avoid that the flanges 73 interfere with the flexing of the spring 77 when the operating member 57 is shifted along the slot 87. The operating assembly is further equipped with a clicking strip 90 that extends parallel to the one of the arrays 64 at the side of the clicking pawl and that is positioned such that in its released condition the clicking pawl 66 is in contact with the clicking strip, whereas in its compressed condition between two catches 65 the clicking pawl 66 is spaced from the clicking strip 90. According to the present example, the clicking strip 90 is of an essentially straight design, but other designs, such as a wavy and/or comb-like shape are also conceivable.

Operation of the operating member 57 will typically start from an indexing position as shown in FIG. 4. In such a position, the indexing pawl 76 is centered relative to one of the catches 65 and engages that catch 65. The clicking pawl 66 is lodged in a corresponding catch 65 on the opposite side of the operating member and is in contact with the clicking strip 90. If, for example, the operating member 57 is operated so that it is slides to the right (direction 61), the clicking pawl 66 and the indexing pawl 76 each encounter a flank 65a of the catch 65 into which it projects. This results in a reaction (indexing) force being exerted via the indexing pawl 76 against the direction of movement, i.e. to the left (direction 60), when the indexing pawl 76 is gradually pushed inwards as the movement of the operating member 57 to the right progresses (see FIG. 5).

A reaction force will also be exerted on the clicking pawl 66 when it encounters the flank 65a of the catch 65 into which it projects. This initially results in the clicking pawl 66 and the leaf spring 67 with which it is integral shifting to an extreme left position within the range of movement relative to the operating member 57 that is allowed by the clearance between the leaf spring 67 and the flanges 73. Subsequently, as the operating member 57 is shifted further, the clicking pawl 66 is also gradually pushed inwards towards the operating member 57 into a position spaced from the clicking strip 90.

When the indexing pawl 76 is about half-way between the centers of consecutive catches 65 (FIG. 5), it has reached a dead center situation in which further movement of the operating member 57 to the right does not result in further compression of the indexing pawl 76 towards the operating member 57, but the indexing pawl 76 is gradually allowed to spring back as the operating member 57 moves further to the right. The contact pressure between the trailing flank 76a of the indexing pawl 76 and a flank 65b of the next catch 65 facing in the direction of movement results in a reaction force having a component to the right, urging the operating member 57 into the next indexing position. This situation is shown in FIG. 6.

In principle, this reaction force to the right may cause the operating member to shift to the next indexing position quickly and to stop abruptly in that next indexing position, so that a positive feedback indicating that the next indexing position is reached may be achieved. However, in practice such an effect is generally not achieved, or only to a marginal extent, because the user holding the operating member 57 inhibits a quick movement of the operating member 57.

This is different for the clicking pawl 66, which is accommodated with clearance 63 parallel to the directions 60, 61 in which the operating member 57 is movable—the clearance being provided at least relative to the portion of the operating member 57 that is normally held by the user. After the clicking pawl 66, which has been urged into an extreme left position within its range of clearance as it was urged out of the catch 65 into which it initially projected, has passed its dead center position between consecutive catches 65, contact pressure between the clicking pawl 66 and a flank 65b of the next catch 65 facing in the direction of movement 61 (to the right) results in a reaction force exerted on the clicking pawl 66 with a component in the direction of movement 61 (to the right). This reaction force causes the clicking pawl 66 and the leaf spring 67 with which it is integral to be displaced very quickly to the right from its extreme left position within its range of clearance relative to the operating member 57. Accordingly, the leaf spring 67 is also suddenly released from its bent state caused by the displacement of the clicking pawl 66 towards the clicking member and shoots outwards, which causes the clicking pawl 66 to hit the clicking strip 90, thus generating a clicking sound and a clicking action that may also be felt by the user via the operating member 57.

Instead of a clicking strip or some other dedicated member forming an abutment that causes the clicking effect when it is hit by the clicking pawl, it may also be provided that the rapid release of the leaf spring 67 after the clicking pawl has passed a dead center position between consecutive catches 65 is stopped when the leaf spring 67 hits a part of the operating member 57, (e.g. the flange 73 of the operating member 57 to the right of the leaf spring 67) or when the clicking pawl 66 hits a flank 65b of the catch 65 it has just entered that faces away from the direction of movement 11 of the operating member 57.

In each of these embodiments, the clicking pawl 66 and the leaf spring 67 with which it is integral are allowed to shoot quickly into the next catch 65 and stopped abruptly, which causes a clicking effect, independent of the velocity with which the operating member 57 is moved into or through its new indexing position.

According to the present example, the thickness of the clicking strip 90 varies along the length of the range of displacement of the operating member 57, this causes the clicking sound to vary with displacement of the operating member 57. A suitable design of the clicking member or members may cause the tone, volume, and/or duration of the clicking sound to vary along the length of the range of displacement of the clicking member, for instance in a gradual and/or repetitive (for instance alternating) manner. It is also possible to design the clicking pawl, the array, and/or the clicking member or members such that different clicking sounds are obtained in dependence on the direction in which the operating member is displaced. A comb-shaped design of the clicking member allows to provide each tooth with an individual design for causing a different clicking sound when the clicking pawl hits the respective tooth.

FIG. 7 shows a third embodiment which is a mechanical inversion of the second embodiment as regards the operation of the assembly. The user-operable operating member 107 is moveable in the direction 60 and the opposite direction 61 relative to the support structure 109 which forms part of a frame or housing of the device. The operating member 107 comprises an opening 106 in which a catch plate 108 is accommodated. The construction of the catch plate is similar to that of the support structure 59 of FIGS. 4-6 and is thus provided with a slot 87 having arrays 64 of catches 65 at two opposite edges of the slot. A carrier plate 110 is accommodated in the slot 87. The construction of the carrier plate is similar to that of the operating member 57 of FIGS. 4-6, i.e. provided with the clicking pawl 66 and indexing pawl 76. For that reason the reference numerals of the parts of the catch plate 108 and the carrier plate 110 are made identical to those of the support structure 59 and operating member 57, respectively, of FIGS. 4-6. The leaf spring 67 with the clicking pawl 65 does not need to be accommodated in the carrier plate 110 with clearance. The clearance 111 in the direction 60, 61 of movement necessary for obtaining the clicking sound is now arranged between the operating member 107 and the catch plate 108. In this third embodiment, the carrier plate 110 is a fixed part of the support structure 109. In operation, the operating member 107 together with the catch plate 108 slides over the carrier plate 110. It will be clear that the operation of the assembly is similar to that described for the second embodiment.

It is observed that many embodiments other than those described by way of example are conceivable within the scope of the present invention. For instance, the clicking and indexing pawls are consistently described as projections arranged for engaging catches in the form of recesses, but, it is also possible to provide an inverse solution in which one or both pawls are provided with recesses that cooperate with an array of catches in the form of projections such as bumps that may be consecutively received in the recesses of the pawl or pawls when the operating member is operated. Also, both the pawls and the catches may be provided with mutually engaging successions of bumps and recesses, such as comb-like structures.

Furthermore, the pawls need not be integral with the resilient structure urging the pawls into contact with at least some parts of the catches, and the resilient structures may also be provided in forms other than as leaf springs.

According to yet another variant, the number of catches for receiving the clicking pawl may be larger or smaller than the number of catches for receiving the indexing pawl. For instance, a clicking effect may only be generated if the operating member reaches selected ones of the indexing positions or a plurality of clicking effects may be generated if the operating member is moved from one indexing position to the next. In such an embodiment it may be advantageous to generate a stronger clicking effect if the operating member reaches an indexing position than while the operating member moves between indexing positions. Similarly, also the other features of the claimed invention are not limited to the above embodiments, which are shown by way of example.

1. An operating assembly (5; 55; 105) for operating a device, comprising:
a support structure (9; 59; 109);
a user-operable operating member (7; 57; 107) moveable in at least one direction of movement (10, 11; 60, 61) relative to the support structure (9; 59; 109) along a plurality of positions;
an array (14; 64) of catches (15; 65) extending along said direction of movement (10, 11; 60, 61); and
a clicking pawl (16; 66) resiliently accommodated for consecutive engagement with and disengagement from said catches (15; 65) of said array (14; 64) in response to the movement of said operating member (7; 57; 107) in said direction of movement (10, 11; 60, 61);
wherein at least said clicking pawl (16; 66) or said array (14; 64) of catches (15; 65) is accommodated in said operating member (7; 57; 107) so as to have a clearance (32; 63; 111) in said direction of movement (10, 11; 60, 61).

2. An operating assembly according to claim 1, further comprising an indexing structure for retaining the operating member (7; 57; 107) in each of a plurality of consecutive and predetermined indexing positions, said indexing positions being determined such that said clicking pawl (16; 66) is in engagement with one of said catches (15; 65) if said operating member (7; 57; 107) is in one of said indexing positions.

3. An operating assembly according to claim 2, wherein said indexing structure comprises an indexing pawl (26; 76) resiliently accommodated for consecutive engagement with and disengagement from an array (14; 64) of catches (15; 65) in response to the movement of said operating member (7; 57) in said direction of movement (10, 11; 60, 61).

4. An operating assembly according to claim 3, wherein said indexing pawl (26; 76) and said clicking pawl (16; 66) are arranged for engagement with and disengagement from the same array (14; 64) of catches (15; 65).

5. An operating assembly according to claim 1, wherein said pawls (16, 26; 66, 76) are supported by a leaf spring (17, 27; 67; 77) or are integrally formed with a leaf spring (17, 27; 67, 77).

6. An operating assembly according to claim 3, wherein said clicking pawl (16) is supported by a leaf spring (17) extending closely adjacent a mounting plate (28) carrying the indexing pawl (26) for causing said leaf spring (17) to hit said mounting plate (28) when said clicking pawl (16) engages one of said catches (15).

7. An operating assembly according to claim 3, wherein said tracks of said array or arrays (14) of catches (15) along which said indexing pawl (26) and said clicking pawl (16) are movable extend coaxially with each other.

8. An operating assembly according to claim 3, wherein said clicking pawl (16; 66) and said indexing pawl (26; 76) each have at least one flank (16a, 26a; 66a, 76a) trailing if said pawl is moved along said array (14; 64) of catches (15; 65), said at least one flank (16a; 66a) of said clicking pawl (16; 66) being steeper than said at least one flank (26a; 76a) of said indexing pawl (26; 76).

9. A device for carrying out a function, at least one characteristic of said function being adjustable between at least two settings, said device comprising an adjustment structure (4) for adjusting said setting, said adjustment structure comprising an operating assembly (5; 55; 105) according to claim 1.

10. A device according to claim 12, comprising a plurality of shaving heads (2) resiliently accommodated in a shaving head holder (3) for resiliently pressing said shaving heads (2) outwards into an outermost position such that a contact pressure to the skin to be shaved is required to press the shaving heads (2) inwards into a shaving position flush with the shaving head holder (3), wherein said adjustment structure (4) is arranged for adjusting said contact pressure.
